(19) United States
(12) Patent Application Publication
(10) Pub. No.: US 2019/0068533 A1
(43) Pub. Date: Feb. 28, 2019

(54) ACQUIRING ATTACHMENTS FROM DATA STORAGE PROVIDERS FOR USE IN ELECTRONIC COMMUNICATIONS

(71) Applicant: Microsoft Technology Licensing, LLC, Redmond, WA (US)

(72) Inventors: Jin MA, Redmond, WA (US); Jun CHEN, Redmond, WA (US); Nathan F. WADDOUPS, Redmond, WA (US); Elena CATRINESCU, Woodinville, WA (US); Rebecca J. LAWLER, Seattle, WA (US); Zohaib RAUF, Seattle, WA (US)

(73) Assignee: Microsoft Technology Licensing, LLC, Redmond, WA (US)

(21) Appl. No.: 15/688,557

(22) Filed: Aug. 28, 2017

(51) Int. Cl. H04L 12/58; H04L 29/06; H04L 29/08

(52) U.S. Cl. CPC H04L 51/08; H04L 63/10; H04L 67/306; H04L 67/42; H04L 67/06

(57) ABSTRACT

Described herein are systems and methods for allowing one or more attachments stored in a data storage provider to be attached to an electronic communication using one or more commands, operations, and/or Application Program Interface (APIs) of a standard protocol. Additionally, one or more reference attachments that each reference or point to a storage location of a file in a data storage provider can be attached to an electronic communication using one or more commands, operations, and/or APIs of a standard protocol. Similarly, one or more files that is stored in a storage device that is associated with an electronic communications application may be accessed by an application using one or more commands, operations, and/or APIs of a standard protocol. One example of a standard protocol is the Web Application Open Platform Interface protocol.

### BACKGROUND

Electronic communications applications or services allow users to send and receive electronic communications over local and distributed networks, such as the Internet. One example of an electronic communications application is an electronic mail (email) application. Email applications or services are provided by a software application installed on a user's computer and by cloud or Internet-based services.

Email applications permit users (senders) to send files (“attachments”) to a recipient by attaching the files to an email message. Typically, electronic communications applications allow users to attach files that are stored in local storage devices but not files that are stored in data storage providers. A data storage provider is generally a cloud-based or Internet-based storage service that is hosted by a company and provides data storage services to multiple users that have accounts with the data storage provider.

In general, an electronic communications application or service has to contain computer instructions or code for accessing a data storage provider in order for a user to be able to attach files stored in the data storage provider to electronic communications. Since users can have accounts at a variety of different data storage providers, an electronic communications application has to include computer instructions that are tailored for and conform to each data storage provider. Writing and maintaining computer code for each data storage provider can be cumbersome, inefficient, and costly for the provider of the electronic communications application or service.

It is with respect to these and other general considerations that embodiments have been described. Also, although relatively specific problems have been discussed, it should be understood that the embodiments should not be limited to solving the specific problems identified in the background.

### SUMMARY

Systems and methods are disclosed herein that allow one or more attachments stored in a data storage provider to be attached to an electronic communication using one or more commands, operations, and/or Application Program Interface (APIs) of a standard protocol. Additionally, one or more reference attachments that each reference or point to a storage location of an attachment in a data storage provider can be attached to an electronic communication using one or more commands, operations, and/or APIs of a standard protocol. Similarly, one or more files that is stored in a storage device that is associated with an electronic communications application may be accessed by an application using one or more commands, operations, and/or APIs of a standard protocol. For example, the files can be attachments that a sender has sent in electronic communications. In one embodiment, the standard protocol is the Web Application Open Platform Interface (WOPI) protocol. As used herein, a standard protocol refers to a set of rules, operations, commands, and/or APIs that allow computing devices to convey a specific set of information. A standard protocol can be defined in a document, a publication, and/or a web site that specifies the protocol and has the support and/or agreement of a standards making body or the industry.

In one aspect, a system includes a communication device, one or more processing units operably connected to the communication device, and one or more storage devices. The storage device(s) store instructions that when executed by the one or more processing units, cause the one or more processing units to perform a method. The method includes receiving a request to attach an attachment to an electronic communication, where the attachment is associated with a file stored in a data storage provider. In response to the request, one or more commands of a standard protocol is sent (via the communication device) to the data storage provider to cause the data storage provider to retrieve the file or information related to the file that references a storage location of the file in the data storage provider. The attachment is then attached, or is caused to be attached, to the electronic communication.

In another aspect, a method includes receiving an indication that an attachment is to be attached to an electronic communication, where the attachment comprising a file stored in a data storage provider. In response to the request, one or more Web Application Open Platform Interface (WOPI) commands is sent to the data storage provider to cause the data storage provider to provide the file stored in the data storage provider. The file is then attached (or is caused to be attached) to the electronic communication.

In yet another aspect, a method includes receiving an indication that a reference attachment is to be attached to an electronic mail message, where the reference attachment includes information that references a storage location of a file stored in a data storage provider. In response to the request, one or more Web Application Open Platform Interface (WOPI) commands is sent to the data storage provider to cause the data storage provider to provide the information. A pointer is then attached (or is caused to be attached) to the electronic mail message, where the pointer includes the information.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures. The elements of the drawings are not necessarily to scale relative to each other. Identical reference numerals have been used, where possible, to designate identical features that are common to the figures.

FIG. 1 illustrates an example system that can include an electronic communications service and a data storage provider;

FIG. 2 is a flowchart depicting a method of adding a new data storage provider to permit files to be attached to electronic communications;

FIG. 3 is a flowchart illustrating a method of attaching an attachment to an electronic communication;

FIG. 4 is a process flow depicting the method shown in FIG. 3;

FIG. 5 is a flowchart illustrating a method of attaching a reference attachment to an electronic communication;

FIG. 6 is a process flow depicting the method shown in FIG. 5;

FIG. 7 is a flowchart illustrating a method of a client accessing a file stored in a storage device associated with an electronic communications application;

FIG. 8 is a block diagram depicting example physical components of a computing device with which aspects of the disclosure may be practiced;

FIGS. 9A-9B are simplified block diagrams illustrating a mobile computing device with which aspects of the present disclosure may be practiced; and

FIG. 10 is a block diagram depicting a distributed computing system in which aspects of the present disclosure may be practiced.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

Embodiments described herein provide systems and methods for allowing one or more attachments stored in a data storage provider to be attached to an electronic communication using one or more commands, operations, and/or Application Program Interface (APIs) of a standard protocol. Additionally, one or more reference attachments that each reference or point to a storage location of an attachment in a data storage provider can be attached to an electronic communication using one or more commands, operations, and/or APIs of a standard protocol. Similarly, one or more files that is stored in a storage device that is associated with an electronic communications application may be accessed by an application using one or more commands, operations, and/or APIs of a standard protocol. As described earlier, the phrase “standard protocol” refers to a set of rules, operations, commands, and/or APIs that allow computing devices to convey a specific set of information. A standard protocol may be defined in a publication that specifies the protocol and has the support and/or agreement of a standards making body or the industry.

Embodiments disclosed herein are described in conjunction with an electronic mail (email) application, email messages, and attachments to the email messages. However, embodiments are not limited to this implementation. Aspects of the disclosure can be used with any suitable type of electronic communications application or service that is operable to attach attachments to the electronic communications (e.g., electronic messages). For example, a texting application or service, a social media service, or an instant messaging application or service can practice aspects of the disclosure.

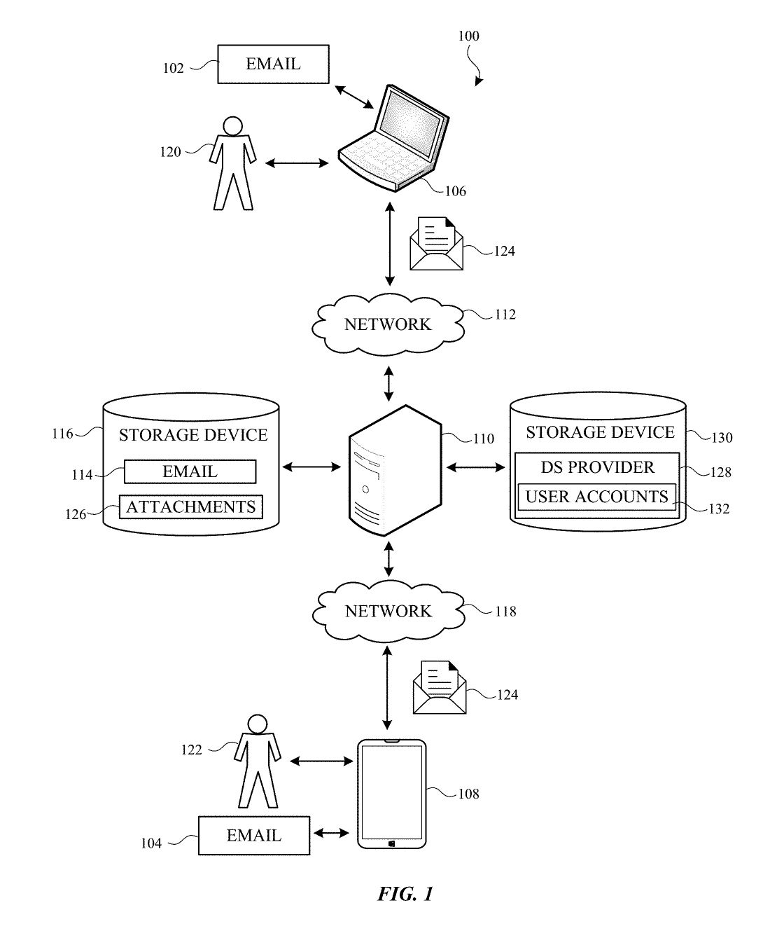

FIG. 1 illustrates an example system that can include an electronic communications service and a data storage provider. The system 100 transmits electronic communications, such as electronic mail (email) messages, between email applications 102, 104 running on client-computing devices 106, 108, respectively. The client-computing device 106 is configured to access one or more server-computing devices (represented by server-computing device 110) through one or more networks (represented by network 112) to interact with an email application 114 stored on one or more storage devices (represented by storage device 116) and executed on the server-computing device 110. Similarly, the client-computing device 108 is configured to access the server-computing device 110 through one or more networks (represented by network 118) to interact with the email application 114.

When the user 120 (“sender”) wants to send an email to the user 122 (“recipient”), the sender 120 generates the email on the client-computing device 106 using the email application 102. The email application 102 transmits the email 124 (via the client-computing device 106) to the server-computing device 110 using the network 112. The email application 114 stores a copy of the email 124 on the storage device 116 and transmits the email 124 (via the server-computing device 110) to the client-computing device 108 using the network 118. Any attachments to the email 124 may be stored in attachments 126 in the storage device 116. The recipient 122 can view the email 124 on the client-computing device 108 using the email application 104.

A data storage (DS) provider 128 is stored on one or more storage devices (represented by storage device 130). The server-computing device 110 may access one or more user accounts 132 provided by the data storage provider 128. A user can store various files of any suitable file type in a user account. Example file types include, but are not limited to, an image file (e.g., a photo), a document file (e.g., word processing document, presentation, spreadsheet, drawing), a video file, a program, an audio file, and/or emails. Using techniques that are described in more detail later, the email application 102 can attach one or more files stored in a user account 132 to the email 124.

In one or more embodiments, each network 112, 118 is illustrative of any suitable type of network, for example, an intranet, and/or a distributed computing network (e.g., the Internet) over which the users 120, 122 may communicate with each other and with other computing systems. Additionally, each client-computing device 106, 108 can be a personal or handheld computing device. For example, the client-computing device 106, 108 may be one of: a mobile telephone; a smart phone; a tablet; a phablet; a smart watch; a wearable computer; a personal computer; a desktop computer; a laptop computer; a gaming device/computer (e.g., Xbox); a television; and the like. This list of example client-computing devices is for example purposes only and should not be considered as limiting. Any suitable client-computing device that provides and/or interacts with one or more email applications and permits users to attach attachments may employ aspects of the disclosure.

As should be appreciated, FIG. 1 is described for purposes of illustrating the present methods and systems and is not intended to limit the disclosure to a particular sequence of steps or a particular combination of hardware or software components. Additionally, Embodiments are not limited to two client-computing devices 106, 108, one server-computing device 110, two networks 112, 118, and two storage devices 116, 130. The system 100 can include any suitable number of server-computing devices, networks, client-computing devices, and/or storage devices.

In the disclosed embodiments, the term “client” refers to a computing device, a software application, and/or a service that requests a file or files (or a copy of the file(s)) and/or interacts with the file(s) stored in the data storage provider. The term “host” refers to a computing device and/or data storage that stores the one or more files. For example, in some embodiments, the client is an electronic communications application running on a computing device (e.g., a client-computing device) and the host is a data storage provider that stores user files and is accessed via a client or a server-computing device. Alternatively, in other embodiments, the client is an application running on a computing device and the host is a storage device that stores user files associated with an electronic communications application and is accessed via a client or a server-computing device.

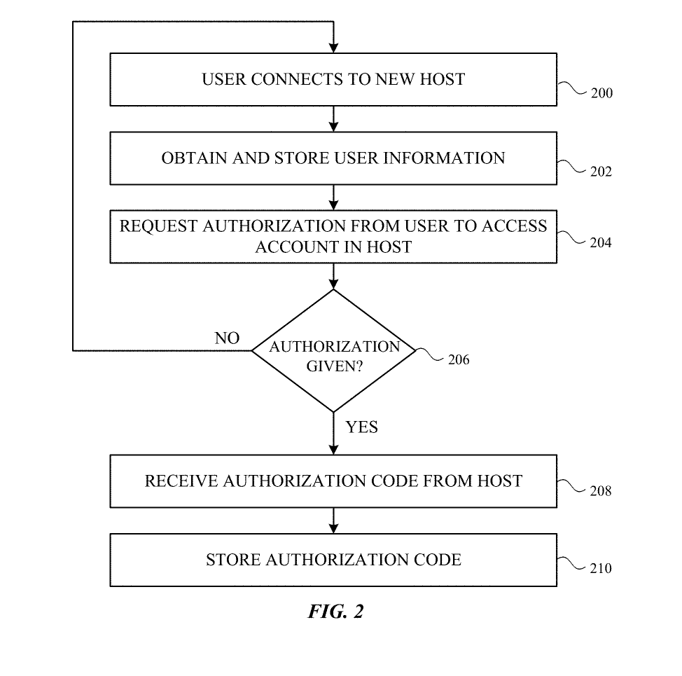

FIG. 2 is a flowchart depicting a method of adding a new data storage provider to permit files to be attached to electronic communications. The illustrated process may be performed by one or more client-computing devices, server-computing devices, or a combination of client and server computing devices. The method is performed to obtain a user's account information that allows the client to request access to a user's account on behalf of the user and permits the host to provide access to the user's account and the files stored therein. One example of an authentication and authorization protocol is Open Authorization (OAuth).

Initially, a user connects to the new host and the user information the user uses to connect to the host is captured and stored (blocks 200, 202). In some embodiments, the user connects to the host using a login screen or page that requests the user to grant his or her permission or authorization to access the user's account on the host (block 204). In aspects, the login page may be specific to an application or an operating system.

A determination is then made at block 206 as to whether the user provided authorization. If not, the process returns to block 200 and repeats when the user connects to the same host or to another new host. When the user provides authorization, the method continues at block 208 where an authorization code or token is received from the host. The received authorization code is then stored at block 210. In some embodiments, the stored authorization code will be used by a client (e.g., an electronic communications application) to access the user's files stored on the host when the user wants to attach one or more of the files to an electronic communication.

Embodiments described herein use a standard protocol to access and retrieve one or more files stored in a host. One example of a standard protocol is the Web Application Open Platform Interface (WOPI) protocol. The WOPI protocol identifies a set of operations or commands that enables a client to access, view, and edit files stored by a computing device (e.g., a server-computing device). When the WOPI protocol is used, the client is referred to as a WOPI client and the host as a WOPI host.

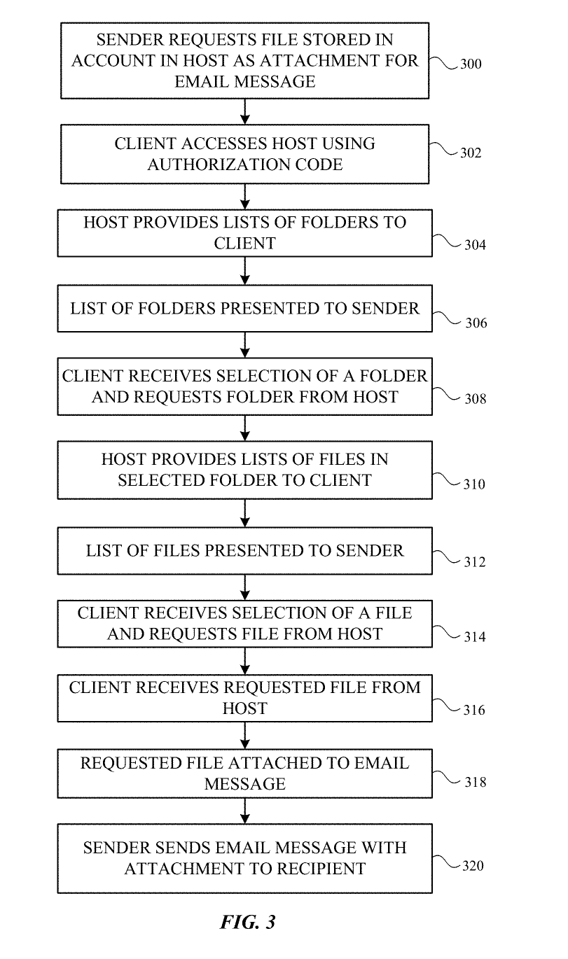

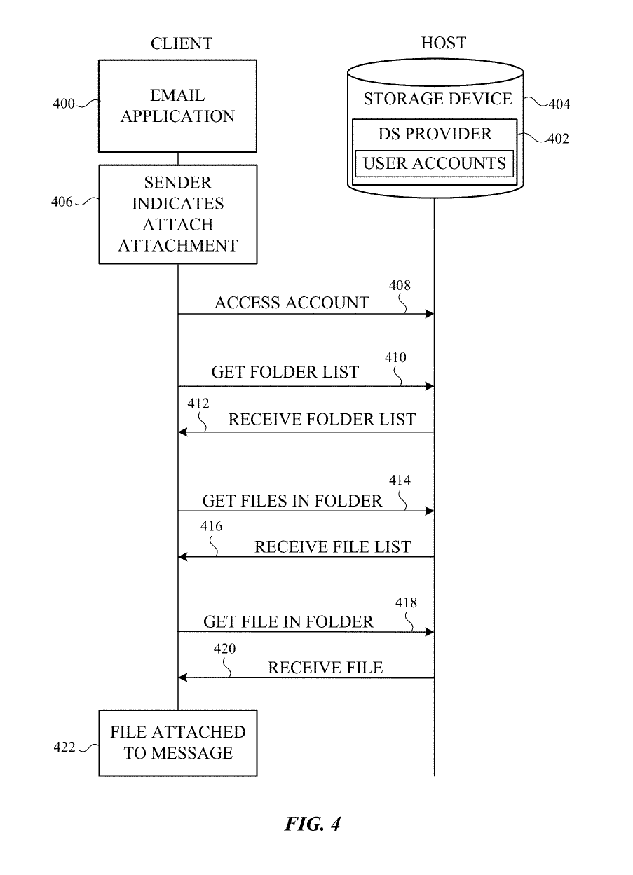

FIG. 3 is a flowchart illustrating a method of attaching an attachment to an electronic communication, and FIG. 4 is a process flow depicting the method shown in FIG. 3. FIGS. 3 and 4 are described in conjunction with a user (“sender”) attaching a file that is stored in a data storage provider to an email message. Accordingly, the email application (400 in FIG. 4) running on a computing device (e.g., client-computing device) is the WOPI client and the data storage provider stored in a data storage is the WOPI host (e.g., data storage provider 402 and storage device 404 in FIG. 4). In FIGS. 3 and 4, the WOPI host serves or provides attachments (e.g., files) to the WOPI client.

Initially, as shown in block 300 in FIG. 3, the sender requests an attachment (e.g., a file) be attached to the email message and the file is stored in the sender's account on the host. FIG. 4 illustrates in block 406 the sender indicating an attachment be attached to the email. For example, the sender can select or click an “attach file” operation or button in the email application or service to initiate the operation in block 300.

In response to the sender requesting the file in block 300, the client accesses the data storage provider 402 using the previously-acquired authorization code (block 302). This operation is depicted in 408 in FIG. 4. In some embodiments, the host provides a list of folders to the client (e.g., email application 400) and the list is presented to the sender (blocks 304, 306). The folder list may be presented to the sender using any suitable technique. For example, the folder list may be displayed to the sender in a panel that is displayed in the email application or is displayed outside of the email application in a user interface.

In FIG. 4, the operation shown in block 304 is produced in response to the WOPI client sending the Application Program Interface (API) that produces a list of folders or containers to the WOPI host (operation 410) and the host providing the folder list to the client (operation 412).

Next, as shown in block 308, the client receives a selected folder in response to the sender selecting the folder in the folder list. The client then requests the selected folder from the host. The host responsively provides a list of the files that are in the selected folder to the client and the file list is presented to the sender (blocks 310, 312). Like the folder list, the file list can be presented to the sender using any suitable technique. For example, the file list may be displayed to the sender in a panel that is displayed in the email application or is displayed outside of the email application.

In FIG. 4, the operations shown in blocks 308 and 310 are performed by the WOPI client sending the API that produces a list of the files in a particular folder to the WOPI host (operation 414) and the WOPI host providing the client with the file list (operation 416).

Next, as shown in block 314, the client receives a selection of a given file in response to the sender selecting the file in the file list and the client requesting the selected file from the host. The host responsively provides the selected file to the client (block 316). The client then attaches (or causes to be attached) the requested file to the email message and sends the email message with the attachment to the recipient (blocks 318, 320).

In FIG. 4, the operations shown in blocks 314 and 316 are performed by the WOPI client sending the API that retrieves the selected file to the WOPI host (operation 418) and the WOPI host providing the file to the client (420). The operation of attaching the file to the email message is illustrated in block 422 in FIG. 4.

In some embodiments, a user may want to share a file that is stored on a data storage provider with other users. The file is maintained on the data storage provider while the user and other users are able to view and/or edit the file. In such embodiments, the user can send an electronic communication (e.g., an email) to the other users with a reference attachment that permits the other users to access the file. A reference attachment includes data that references or points to (a “pointer”) the storage location of the file.

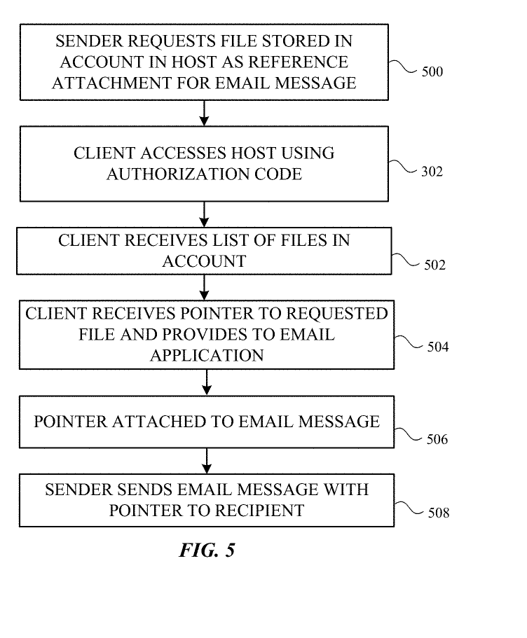

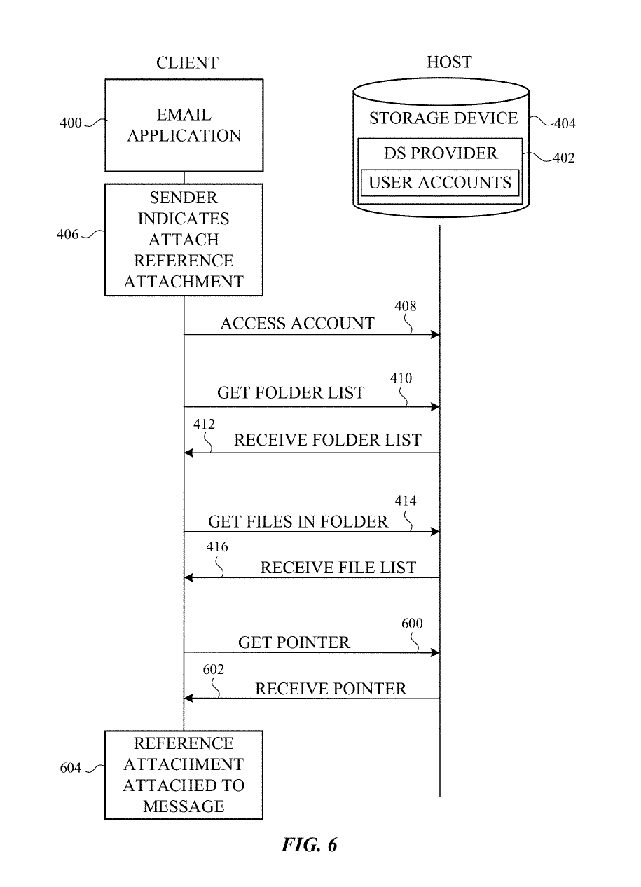

FIG. 5 is a flowchart illustrating a method of attaching a reference attachment to an electronic communication and FIG. 6 is a process flow depicting the method shown in FIG. 5. FIGS. 5 and 6 are described in conjunction with a user (“sender”) attaching a reference attachment to an email message. Accordingly, the email application (400 in FIG. 6) running on a computing device (e.g., client-computing device) is the WOPI client and the data storage provider stored in a data storage is the WOPI host (e.g., data storage provider 402 and storage device 404 in FIG. 6). In FIGS. 5 and 6, the WOPI host serves or provides the reference attachment to the WOPI client.

Initially, as shown in block 500 in FIG. 5, the sender requests a reference attachment be attached to the email message and the referenced attachment (e.g., a file) is stored in the sender's account on the host. FIG. 6 illustrates in block 406 the sender indicating a reference attachment is to be attached in the email application or service. For example, the sender can select an “attach file” operation or button to initiate the operation in block 500.

The client accesses the host using the previously-acquired authorization code, which is depicted in block 302 in FIGS. 5 and 408 in FIG. 6. In block 502, the client receives a list of files in the user's account in the data storage provider in response to the receipt of one or more commands or APIs of a standard protocol. Block 502 can include the operations shown in blocks 304, 306, 308, 310, and 312 in FIG. 3 and the operations depicted in 410, 412, 414, and 416 in FIGS. 4 and 6.

Next, as shown in block 504, the client receives a pointer that includes the information or data that points to the storage location of the referenced file in response to the receipt of one or more commands or APIs of the standard protocol and provides the pointer to the email application. Block 504 may include the operation shown in block 314 in FIG. 3 and the operations 600 and 602 in FIG. 6. In operation 600, the client sends the API that requests the pointer and the host responds by sending the pointer in operation 602. The client then attaches (or causes to be attached) the pointer to the email message and sends the email message with the pointer to the recipient (blocks 506, 508). The operation of attaching the pointer to the email message is illustrated in block 604 in FIG. 6.

Although FIGS. 1-6 are described in conjunction with an email application and an email with one or more attachments, other embodiments are not limited to this type of electronic communications. Embodiments of the invention can be implemented with any suitable electronic communications program that is operable to attach attachments to the electronic communications (e.g., electronic messages). For example, a texting application or an instant messaging application can practice aspects of the disclosure.

Additionally, FIGS. 1-6 are described in conjunction with a single file or a reference attachment being attached to an electronic communication. However, embodiments are not limited to one file or reference attachment. Any number of files that are stored in a data storage provider, or any number of reference attachments referencing files that are stored in a data storage provider, can be attached to an electronic communication.

As discussed earlier, in some embodiments, a client is an application running on a computing device and a host is a storage device that stores user files associated with an electronic communications application (e.g., an email application). In aspects, the user files are copies of attachments that the user has sent previously in email messages. For example, in FIG. 1, an application (other than the email application 102) running on the client-computing device 106 can be a client that wants to access, edit, and/or share a file stored in the attachments 126 in the storage device 116. In some embodiments, the application that accesses one or more files stored in the storage device associated with an electronic communications application is a non-electronic communications application. Example non-electronic communications applications include, but are not limited to, word processing applications, file sharing applications, web browsers, presentation applications, desktop publishing applications, and the like.

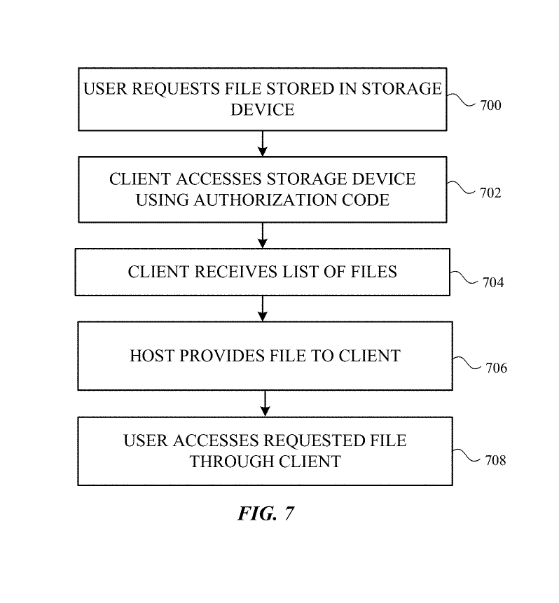

FIG. 7 is a flowchart illustrating a method of a client accessing a file stored in a storage device associated with an electronic communications application or service. In the illustrated embodiment, an application or service running on a computing device (e.g., client-computing device) is the WOPI client and the storage device is the WOPI host. For example, in one embodiment, the application is a non-electronic communications application or service. In FIG. 7, the WOPI host serves or provides files to the WOPI client.

Initially, as shown in block 700, a user requests one or more files that is stored in the storage device. The client responsively accesses the host using a previously-acquired authorization code (block 702). In block 704, the client receives a list of files in the user's account in the storage device in response to the receipt of one or more commands or APIs of a standard protocol. Block 704 can include the operations shown in blocks 304, 306, 308, 310, and 312 in FIG. 3. Next, as shown in block 706, the host provides the file(s) to the client in response to the receipt of one or more commands or APIs of the standard protocol. Block 706 may include the operation shown in blocks 314 and 316 in FIG. 3. The user is then able to access the file(s) through the client.

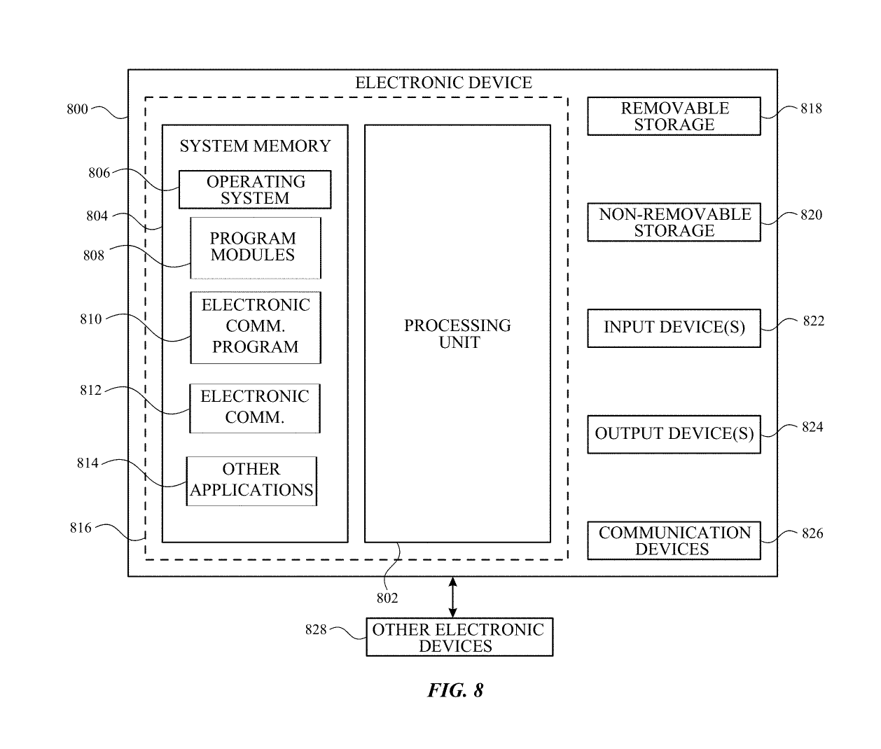

FIGS. 8-10 and the associated descriptions provide a discussion of a variety of operating environments in which aspects of the disclosure may be practiced. However, the devices and systems illustrated and discussed with respect to FIGS. 8-10 are for purposes of example and illustration and are not limiting of a vast number of electronic device configurations that may be utilized for practicing aspects of the disclosure, as described herein.

FIG. 8 is a block diagram illustrating physical components (e.g., hardware) of an electronic device 800 with which aspects of the disclosure may be practiced. The components described below may be suitable for the computing devices described above, including the client-computing devices 106, 108 and/or the server-computing device 110 in FIG. 1.

In a basic configuration, the electronic device 800 may include at least one processing unit 802 and a system memory 804. Depending on the configuration and type of the electronic device, the system memory 804 may comprise, but is not limited to, volatile storage (e.g., random access memory), non-volatile storage (e.g., read-only memory), flash memory, or any combination of such memories. The system memory 804 may include a number of program modules and data files, such as an operating system 806, one or more program modules 808 suitable for parsing received input, determining subject matter of received input, determining actions associated with the input and so on, an electronic communication program 810, electronic communications or files 812, and/or other programs 814 (e.g., non-electronic communications programs). While executing on the processing unit 802, the instructions in the electronic communication program 810 and/or the other programs 814 may perform and/or cause to be performed processes including, but not limited to, the aspects as described herein.

The operating system 806, for example, may be suitable for controlling the operation of the electronic device 800. Furthermore, embodiments of the disclosure may be practiced in conjunction with a graphics library, other operating systems, or any other application program and is not limited to any particular application or system. This basic configuration is illustrated in FIG. 8 by those components within a dashed line 816.

The electronic device 800 may have additional features or functionality. For example, the electronic device 800 may also include additional data storage devices (removable and/or non-removable) such as, for example, magnetic disks, optical disks, or tape. Such additional storage is illustrated in FIG. 8 by a removable storage device 818 and a non-removable storage device 820.

The electronic device 800 may also have one or more input device(s) 822 such as a keyboard, a trackpad, a mouse, a pen, a sound or voice input device, a touch, force and/or swipe input device, etc. The output device(s) 824 such as a display, speakers, a printer, etc. may also be included. The aforementioned devices are examples and others may be used. The electronic device 800 may include one or more communication devices 826 allowing communications with other electronic devices 828. Examples of suitable communication devices 826 include, but are not limited to, radio frequency (RF) transmitter, receiver, and/or transceiver circuitry; universal serial bus (USB), parallel, and/or serial ports.

The term computer-readable media as used herein may include computer storage media. Computer storage media may include volatile and nonvolatile, removable and non-removable media implemented in any method or technology for storage of information, such as computer readable instructions, data structures, or program modules.

The system memory 804, the removable storage device 818, and the non-removable storage device 820 are all computer storage media examples (e.g., memory storage or storage device). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the electronic device 800. Any such computer storage media may be part of the electronic device 800. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 8 may be integrated onto a single integrated circuit. Such an SOC device may include one or more processing units, graphics units, communications units, system virtualization units and various application functionality all of which are integrated (or “burned”) onto the chip substrate as a single integrated circuit.

When operating via an SOC, the functionality described herein may be operated via application-specific logic integrated with other components of the electronic device 800 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

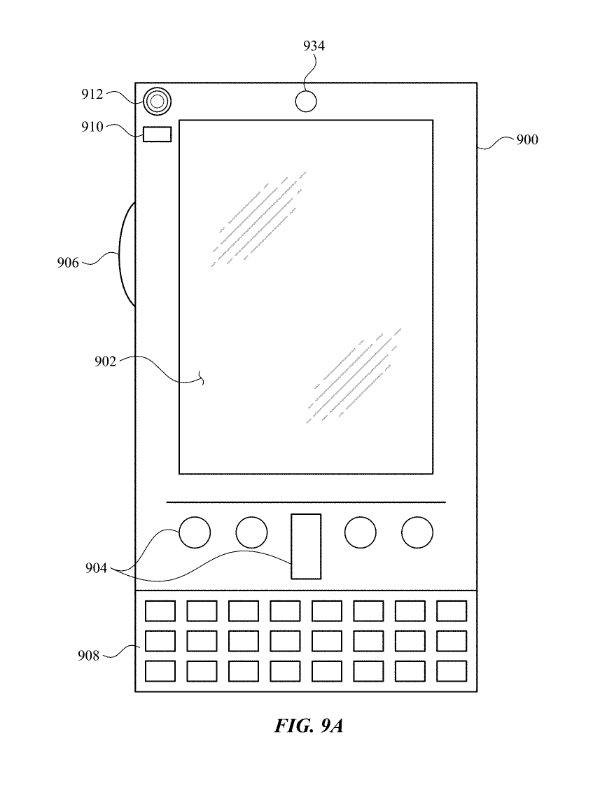

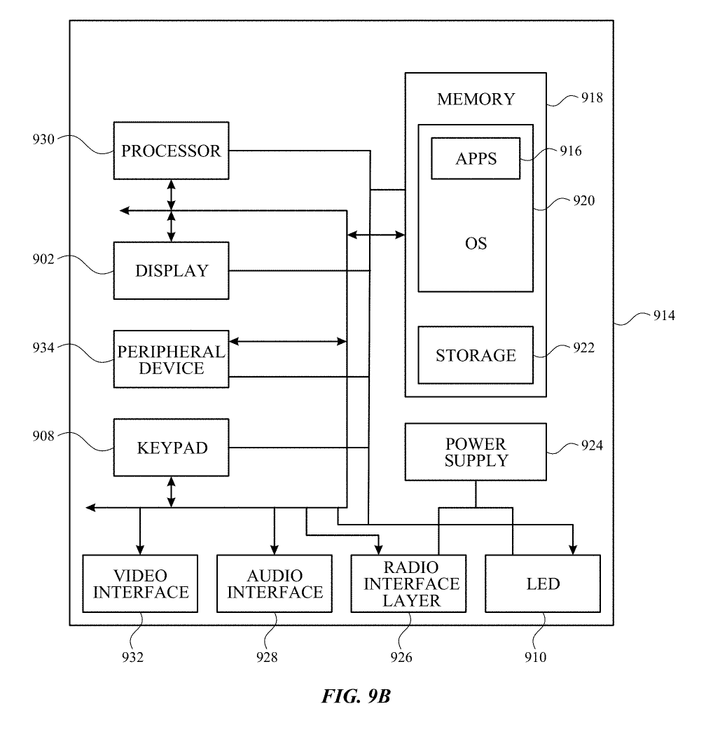

FIGS. 9A and 9B illustrate a mobile electronic device 900, for example, a mobile telephone, a smart phone, wearable computer (such as a smart watch), a tablet computer, a laptop computer, and the like, with which embodiments of the disclosure may be practiced. With reference to FIG. 9A, one aspect of a mobile electronic device 900 for implementing the aspects is illustrated.

In a basic configuration, the mobile electronic device 900 is a handheld computer having both input elements and output elements. The mobile electronic device 900 typically includes a display 902 and one or more input buttons 904 that allow the user to enter information into the mobile electronic device 900. The display 902 of the mobile electronic device 900 may also function as an input device (e.g., a display that accepts touch and/or force input).

If included, an optional side input element 906 allows further user input. The side input element 906 may be a rotary switch, a button, or any other type of manual input element. In alternative aspects, mobile electronic device 900 may incorporate more or less input elements. For example, the display 902 may not be a touch screen in some embodiments. In yet another alternative embodiment, the mobile electronic device 900 is a portable phone system, such as a cellular phone. The mobile electronic device 900 may also include an optional keypad 908. Optional keypad 908 may be a physical keypad or a “soft” keypad generated on the touch screen display.

In various embodiments, the output elements include the display 902 for showing a graphical user interface (GUI) and a set of available templates, a visual indicator 910 (e.g., a light emitting diode), and/or an audio transducer 912 (e.g., a speaker). In some aspects, the mobile electronic device 900 incorporates a vibration transducer for providing the user with tactile feedback. In yet another aspect, the mobile electronic device 900 incorporates input and/or output ports, such as an audio input (e.g., a microphone jack), an audio output (e.g., a headphone jack), and a video output (e.g., a HDMI port) for sending signals to or receiving signals from an external device.

FIG. 9B is a block diagram illustrating the architecture of one aspect of a mobile electronic device 900. That is, the mobile electronic device 900 can incorporate a system (e.g., an architecture) 914 to implement some aspects. In one embodiment, the system 914 is implemented as a “smart phone” capable of running one or more applications (e.g., browser, e-mail, calendaring, contact managers, messaging clients, games, media clients/players, content selection and sharing applications and so on). In some aspects, the system 914 is integrated as an electronic device, such as an integrated personal digital assistant (PDA) and wireless phone.

One or more application programs 916 may be loaded into the memory 918 and run on or in association with the operating system 920. Examples of the application programs include phone dialer programs, e-mail programs, personal information management (PIM) programs, word processing programs, spreadsheet programs, Internet browser programs, messaging programs, and so forth.

The system 914 also includes a non-volatile storage area 922 within the memory 918. The non-volatile storage area 922 may be used to store persistent information that should not be lost if the system 914 is powered down.

The application programs 916 may use and store information in the non-volatile storage area 922, such as email, attachments or other messages used by an email application, and the like. A synchronization application (not shown) also resides on the system 914 and is programmed to interact with a corresponding synchronization application resident on a host computer to keep the information stored in the non-volatile storage area 922 synchronized with corresponding information stored at the host computer.

The system 914 has a power supply 924, which may be implemented as one or more batteries. The power supply 924 may further include an external power source, such as an AC adapter or a powered docking cradle that supplements or recharges the batteries.

The system 914 may also include a radio interface layer 926 that performs the function of transmitting and receiving radio frequency communications. The radio interface layer 926 facilitates wireless connectivity between the system 914 and the “outside world,” via a communications carrier or service provider. Transmissions to and from the radio interface layer 926 are conducted under control of the operating system 920. In other words, communications received by the radio interface layer 926 may be disseminated to the application programs 916 via the operating system 920, and vice versa.

The visual indicator 910 may be used to provide visual notifications, and/or an audio interface 928 may be used for producing audible notifications via an audio transducer (e.g., audio transducer 912 illustrated in FIG. 9A). In the illustrated embodiment, the visual indicator 910 is a light emitting diode (LED) and the audio transducer 912 may be a speaker. These devices may be directly coupled to the power supply 924 so that when activated, they remain on for a duration dictated by the notification mechanism even though the processor 930 and other components might shut down for conserving battery power. The LED may be programmed to remain on indefinitely until the user takes action to indicate the powered-on status of the device.

The audio interface 928 is used to provide audible signals to and receive audible signals from the user (e.g., voice input such as described above). For example, in addition to being coupled to the audio transducer 912, the audio interface 928 may also be coupled to a microphone to receive audible input, such as to facilitate a telephone conversation. In accordance with embodiments of the present disclosure, the microphone may also serve as an audio sensor to facilitate control of notifications, as will be described below.

The system 914 may further include a video interface 932 that enables an operation of peripheral device 934 (e.g., on-board camera) to record still images, video stream, and the like.

A mobile electronic device 900 implementing the system 914 may have additional features or functionality. For example, the mobile electronic device 900 may also include additional data storage devices (removable and/or non-removable) such as, magnetic disks, optical disks, or tape. Such additional storage is illustrated in FIG. 9B by the non-volatile storage area 922.

Data/information generated or captured by the mobile electronic device 900 and stored via the system 914 may be stored locally on the mobile electronic device 900, as described above, or the data may be stored on any number of storage media that may be accessed by the device via the radio interface layer 926 or via a wired connection between the mobile electronic device 900 and a separate electronic device associated with the mobile electronic device 900, for example, a server-computing device in a distributed computing network, such as the Internet (e.g., server-computing device 110 or 118 in FIG. 1). As should be appreciated such data/information may be accessed via the mobile electronic device 900 via the radio interface layer 926 or via a distributed computing network. Similarly, such data/information may be readily transferred between electronic devices for storage and use according to well-known data/information transfer and storage means, including electronic mail and collaborative data/information sharing systems.

As should be appreciated, FIG. 9A and FIG. 9B are described for purposes of illustrating the present methods and systems and is not intended to limit the disclosure to a particular sequence of steps or a particular combination of hardware or software components.

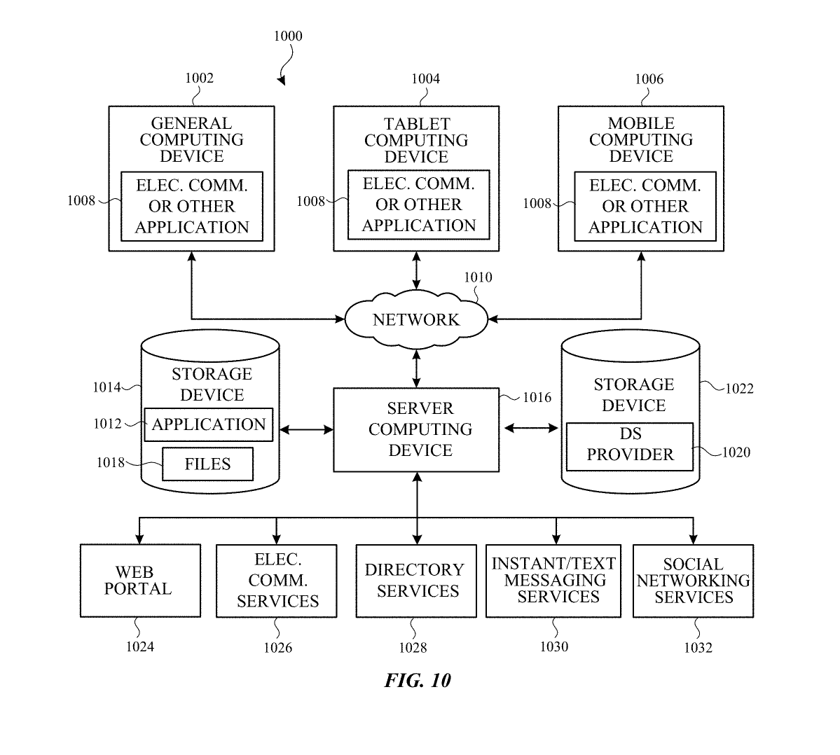

FIG. 10 is a block diagram illustrating a distributed system in which aspects of the disclosure may be practiced. The system 1000 allows a user to send and receive electronic communications that include one or more attachments through a general computing device 1002 (e.g., a desktop computer), a tablet computing device 1004, and/or a mobile computing device 1006. The general computing device 1002, the tablet computing device 1004, and the mobile computing device 1006 can each include the components, or be connected to the components, that are shown associated with the electronic device 800 in FIG. 8. Additionally, the general computing device 1002, the tablet computing device 1004, and the mobile computing device 1006 each include an electronic communications application or other non-electronic communications applications 1008.

The general computing device 1002, the tablet computing device 1004, and the mobile computing device 1006 are each configured to access one or more networks (represented by network 1010) to interact with the application 1012 (electronic communications or non-electronic communications application) stored in one or more storage devices (represented by storage device 1014) and executed on one or more server-computing devices (represented by server-computing device 1016). One or more files 1018 can also be stored in the storage device 1014.

Additionally, the general computing device 1002, the tablet computing device 1004, and the mobile computing device 1006 are each configured to access the network 1010 to interact with (via the server-computing device 1016) the data storage provider 1020 stored in one or more storage devices (represented by storage device 1022). In some aspects, the server-computing device 1016 can access and/or receive various types of services, communications, documents and information transmitted from other sources, such as a web portal 1024, an electronic communications services 1026, directory services 1028, instant messaging and/or text services 1030, and/or social networking services 1032. In some instances, these sources may provide robust reporting, analytics, data compilation and/or storage service, etc., whereas other services may provide search engines or other access to data and information, images, videos, document processing and the like.

As should be appreciated, FIG. 10 is described for purposes of illustrating the present methods and systems and is not intended to limit the disclosure to a particular sequence of steps or a particular combination of hardware or software components.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

1. A system, comprising:
a communication device;
one or more processing units operably connected to the communication device; and
one or more storage devices storing instructions that when executed by the one or more processing units, cause the one or more processing units to perform a method comprising:
receiving a request to attach an attachment to an electronic communication, the attachment associated with a file stored in a data storage provider;
in response to the request, sending, through the communication device, one or more commands of a standard protocol to the data storage provider to cause the data storage provider to retrieve the file or information related to the file that references a storage location of the file in the data storage provider; and
causing the attachment to be attached to the electronic communication.

2. The system of claim 1, wherein the standard protocol comprises a Web Application Open Platform Interface (WOPI) protocol.

3. The system of claim 1, wherein the method further comprises prior to sending the one or more commands of the standard protocol, sending, through the communication device, at least one command of an authentication and authorization protocol to access the data storage provider.

4. The system of claim 3, wherein the authentication and authorization protocol comprises Open Authorization.

5. The system of claim 1, wherein the attachment comprises the file.

6. The system of claim 1, wherein the attachment comprises a reference attachment.

7. The system of claim 1, wherein the method further comprises sending the electronic communication and the attachment to a recipient.

8. A method, comprising:
receiving an indication that an attachment is to be attached to an electronic communication, the attachment comprising a file stored in a data storage provider;
in response to the request, sending one or more Web Application Open Platform Interface (WOPI) commands to the data storage provider to cause the data storage provider to provide the file stored in the data storage provider; and
causing the file to be attached to the electronic communication.

9. The method of claim 8, wherein the one or more WOPI commands comprises a first WOPI Application Program Interface (API) that causes the data storage provider to provide a list of folders in the data storage provider and the method further comprises:
causing the list of folders to be displayed; and
in response to the displayed list of folders, receiving a selection of a particular folder.

10. The method of claim 9, wherein the one or more WOPI commands comprises a second WOPI API that causes the data storage provider to provide a list of files of one or more files stored in the selected folder and the method further comprises:
causing the list of files to be displayed; and
in response to the displayed list of files, receiving a selection of a particular file.

11. The method of claim 10, wherein the one or more WOPI commands comprises a third WOPI API that causes the data storage provider to provide the selected file.

12. The method of claim 8, wherein the electronic communication comprises an electronic mail message.

13. The method of claim 8, further comprising prior to sending the one or more WOPI commands to the data storage provider, sending at least one command of an authentication and authorization protocol to access the data storage provider.

14. The method of claim 13, wherein the authentication and authorization protocol comprises Open Authorization.

15. The method of claim 8, wherein the method further comprises sending the electronic communication and the attachment to a recipient.

16. A method, comprising:
receiving an indication that a reference attachment is to be attached to an electronic mail message, the reference attachment comprising information that references a storage location of a file stored in a data storage provider;
in response to the request, sending one or more Web Application Open Platform Interface (WOPI) commands to the data storage provider to cause the data storage provider to provide the information; and
causing a pointer to be attached to the electronic mail message, the pointer comprising the information.

17. The method of claim 16, wherein the method further comprises sending the electronic mail message and the attached reference attachment to a recipient.

18. The method of claim 16, further comprising prior to sending the one or more WOPI commands to the data storage provider, sending at least one command of an authentication and authorization protocol to access the data storage provider.

19. The method of claim 16, wherein the one or more WOPI commands comprises a first WOPI Application Program Interface (API) that causes the data storage provider to provide a list of folders in the data storage provider and the method further comprises:
causing the list of folders to be displayed; and
in response to the displayed list of folders, receiving a selection of a particular folder.

20. The method of claim 19, wherein:
the one or more WOPI commands comprises a second WOPI API and a third WOPI API, the second WOPI API causing the data storage provider to provide a list of files of one or more files stored in the selected folder and the method further comprises:
causing the list of files to be displayed; and
in response to the displayed list of files, receiving a selection of a particular file; and
the third WOPI API causing the data storage provider to provide the information.
